(19) United States
(12) Patent Application Publication
(10) Pub. No.: US 2017/0371428 A1
(43) Pub. Date: Dec. 28, 2017

(54) OUTPUT CONTROL SYSTEM, OUTPUT CONTROL METHOD, AND NON-TRANSITORY COMPUTER-READABLE RECORDING MEDIUM

(71) Applicant: CASIO COMPUTER CO., LTD., Tokyo (JP)

(72) Inventor: Kunihiro MATSUBARA, Tokyo (JP)

(73) Assignee: CASIO COMPUTER CO., LTD., Tokyo (JP)

(21) Appl. No.: 15/498,618

(22) Filed: Apr. 27, 2017

(30) Foreign Application Priority Data
Jun. 23, 2016 (JP) 2016-124259

(51) Int. Cl. G06F 3/0346

(52) U.S. Cl. CPC G06F 3/0346

(57) ABSTRACT

An output control system and the like that can control output of a content according to the movement of the user on a moving device is provided. An output control device acquires from a control device moving conditions of an escalator such as the moving speed, moving distance, and moving direction. Then, the output control device divides a content based on the acquired moving conditions and the number of displays to create divided data. Then, the output control device outputs the divided data to the displays in every unit time determined based on the acquired moving conditions in accordance with the moving direction of the escalator.

### CROSS-REFERENCE TO RELATED APPLICATION

This application claims the benefit of Japanese Patent Application No. 2016-124259, filed on Jun. 23, 2016, the entire disclosure of which is incorporated by reference herein.

### FIELD

This application relates generally to an output control system, output control method, and non-transitory computer-readable recording medium for controlling output of contents.

### BACKGROUND

In the prior art, there are systems providing contents to users by projecting the contents on a screen. For example, Unexamined Japanese Patent Application Kokai Publication No. 2011-150221 discloses a technique of projecting a content on a screen shaped into the contour of the content when a person is detected by a motion sensor.

### SUMMARY

However, techniques as in the above publication can output a content according to the presence/absence of a user; however, it is difficult to control output of a content according to the movement of the user on a moving device such as an escalator.

The present disclosure is made with the view of the above situation and an objective of the disclosure is to provide an output control system and the like that can control output of a content according to the movement of the user on a moving device.

An output control system, comprising:

a display outputting a content;

an acquirer acquiring a moving condition of a moving device; and

a CPU changing output of the content to the display based on the acquired moving condition.

The present disclosure makes it possible to control output of a content according to the movement of the user on a moving device.

### BRIEF DESCRIPTION OF THE DRAWINGS

A more complete understanding of this application can be obtained when the following detailed description is considered in conjunction with the following drawings, in which:

FIG. 1 is an illustration showing the configuration in appearance of the output control system according to Embodiment 1;

FIG. 2 is a schematic diagram showing the configuration of the output control device according to Embodiment 1;

FIG. 3A is a chart showing an exemplary method of dividing a content according to Embodiment 1;

FIG. 3B is a chart showing exemplary data saved in the contents DB according to Embodiment 1;

FIG. 4 is a chart showing transition with time of divided data the output controller outputs to the displays;

FIG. 5 is an exemplary flowchart of the divided data creation procedure according to Embodiment 1;

FIG. 6 is an exemplary flowchart of the output control procedure according to Embodiment 1;

FIG. 7A is a chart showing an exemplary method of dividing a content according to Embodiment 2;

FIG. 7B is a chart showing exemplary data saved in the contents DB according to Embodiment 2; and

FIG. 8 is an exemplary flowchart of the divided data creation procedure according to Embodiment 2.

### DETAILED DESCRIPTION

Embodiments of the present disclosure will be described below with reference to the drawings.

### Embodiment 1

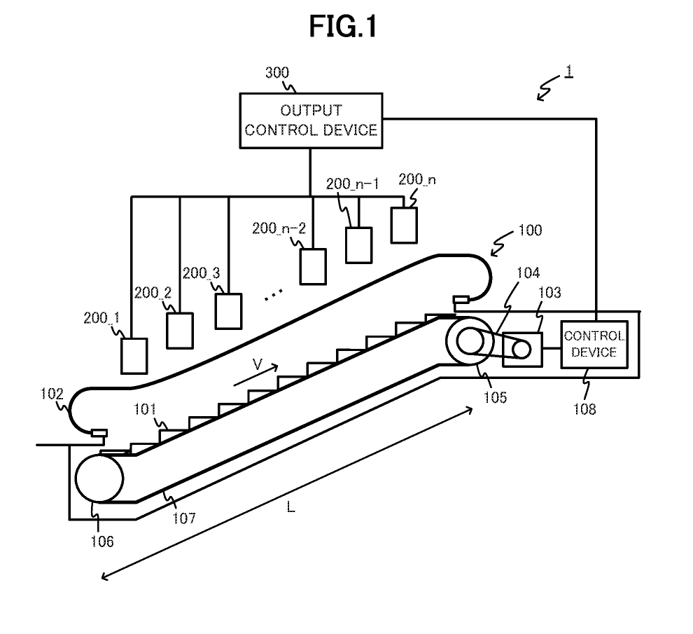

FIG. 1 is an illustration showing the configuration in appearance of an output control system 1 according to Embodiment 1 of the present disclosure. The output control system 1 is a system installed, for example, at a store front or in a public facility and controlling digital signage (so-called electronic signs) displaying contents such as guide signs and advertisements to the user who is a viewer.

As shown in FIG. 1, the output control system 1 comprises an escalator 100, n displays 200_1 to 200_n (n is a natural number), and an output control device 300.

The escalator 100 is an example of the moving device of the present disclosure. The escalator 100 shown in FIG. 1 is of a schematic side view presenting the overall configuration. The escalator 100 is configured so that multiple stairs 101 and handrails 102 circulate in conjunction with a drive device 103. The drive device 103 includes a motor or the like and rotates an upper sprocket 105 via a drive chain 104 with the torque generated by the motor. A staircase chain 107 goes round between the upper sprocket 105 and a lower sprocket 106 and the stairs 101 move in conjunction with the staircase chain 107. Moreover, the operation of the drive device 103 is controlled by a control device 108.

The control device 108 is a device controlling the operation of the escalator 100. In this embodiment, the control device 108 stores information presenting moving conditions, for example the moving speed, moving distance, and moving direction, of the escalator 100, and controls the operation of the escalator 100 according to the prestored information.

The displays 200_1 to 200_n are each a device displaying a content output by the output control device 300 and comprise, for example, a liquid crystal display (LCD), an electroluminance (EL) display, or the like. In this embodiment, the displays 200_1 to 200_n are disposed at equal intervals along the moving direction of the escalator 100. Moreover, the reference numbers 200_1 to 200_n are assigned to the displays 200_1 to 200_n in sequence in accordance with the moving direction (upward in FIG. 1).

The output control device 300 controls output of a content to the displays 200 according to the moving conditions of the escalator 100.

The configuration of the output control device 300 will be described in detail next.

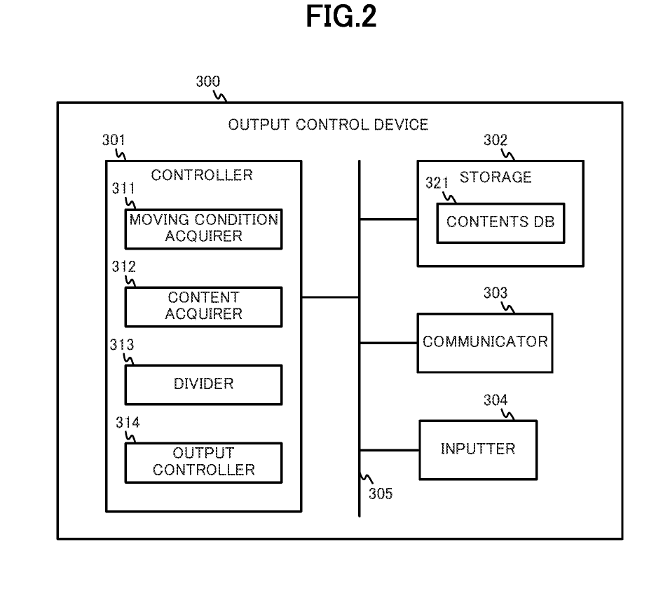

FIG. 2 is a schematic diagram showing the configuration of the output control device 300. As shown in FIG. 2, the output control device 300 comprises a controller 301, a storage 302, a communicator 303, and an inputter 304. These parts are connected by a bus 305.

The controller 301 comprises a central processing unit (CPU), a read only memory (ROM), and a random access memory (RAM). The controller 301 executes programs (for example, programs regarding the divided data creation procedure and the output control procedure, which are described later) stored in the ROM to realize the functions of a moving condition acquirer 311, a content acquirer 312, an divider 313, and an output controller 314, which are described later.

The storage 302 is a nonvolatile memory such as a hard disk drive (HDD). The storage 302 stores various contents to output to the displays 200. Moreover, the storage 302 stores a contents database (DB) 321 described later.

The communicator 303 comprises a communication interface for communicably connecting the output control device 300 to the control device 108 of the escalator 100 and the displays 200_1 to 200_n.

The inputter 304 comprises an input device such as buttons, a keyboard, or a touch panel. The inputter 304 receives operation input from the user of the output control device 300 and outputs signals corresponding to the received operation input to the controller 301.

The functional configuration of the controller 301 of the output control device 300 will be described next. As shown in FIG. 2, the controller 301 functions as a moving condition acquirer 311, a content acquirer 312, a divider 313, and an output controller 314.

The moving condition acquirer 311 acquires moving conditions of the escalator 100. For example, the moving condition acquirer 311 acquires information presenting the moving speed, moving distance, and moving direction of the escalator 100 (the movement information) from the control device 108 of the escalator 100.

The content acquirer 312 acquires a content to output to the displays 200_1 to 200_n. The content to output to the displays 200_1 to 200_n is, for example, a video image. The content acquirer 312 may acquire a content from an external device via a network (not shown) or may acquire a content presaved in the storage 302. Moreover, the content acquirer 312 may acquire multiple contents.

The divider 313 divides the content acquired by the content acquirer 312 to create divided data to output to each of the displays 200_1 to 200_n. Then, the divider 313 saves each of the created divided data in the contents DB 321 in association with the displays 200_1 to 200_n in sequence from the beginning of the content in accordance with the moving direction of the escalator 100.

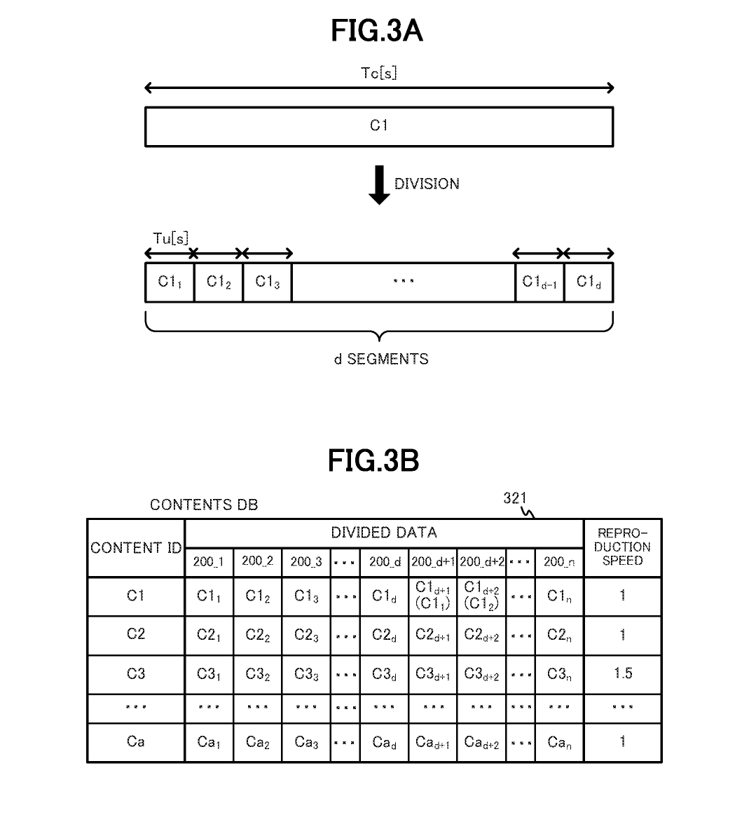

A method of creating divided data and exemplary saving in the contents DB 321 will be described below using FIGS. 3A and 3B. FIG. 3A is a chart showing an exemplary method of dividing a content and FIG. 3B is a chart showing exemplary data saved in the contents DB 321. In this example, the divider 313 divides a content into unit times determined based on the moving conditions of the escalator 100.

First, it is assumed that the moving condition acquirer 311 acquires a moving speed V [m/s], a moving distance L [m], a moving direction of up as the moving conditions of the escalator 100 as shown in FIG. 1. In such a case, the divider 313 calculates a time from the user getting on the escalator 100 to getting off the same (a moving time), T, by T=L/V [s]. Moreover, the divider 313 calculates a unit time Tu for which each of the displays 200_1 to 200_n displays the divided data by Tu=T/n [s].

Next, when the moving time T [s] is equal to or longer than the total length Tc [s] of a content, the divider 313 calculates a division number d as the result of dividing the total length Tc of the content into unit times Tu by d=Tc/Tu. Then, the divider 313 divides the content by the division number d to create divided content segments as divided data. For example, as shown in FIG. 3A, when a content C1 has a total length Tc [s], the divider 313 divides the content C1 into unit times Tu [s] to create d divided data C11 to C1d.

Moreover, the divider 313 saves each of the created divided data in the contents DB 321 in association with each of the displays 200_1 to 200_n in sequence from the beginning of the content in accordance with the moving direction of the escalator 100. For example, when d divided data C11 to C1d are created from a content C1 as shown in FIG. 3A, the divider 313 saves the divided data C11 to C1d in the contents DB 321 in association with the displays 200_1 to 200_d as shown in FIG. 3B.

Moreover, when the division number d is smaller than the number of displays 200_1 to 200_n, n, the divider 313 saves the divided data in the contents DB 321 in association with the d+l-th and subsequent displays 200_d+1 to 200_n in sequence from the beginning of the content. For example, when the division number d of a content C1 shown in FIG. 3A is smaller than the number of displays 200_1 to 200_n, n, the divider 313 saves the divided data C11, C12, . . . in the contents DB 321 as divided data C1d+1 to C1n associated with the d+1-th and subsequent displays 200_d+1 to 200_n as shown in FIG. 3B.

Moreover, when the moving time T [s] is shorter than the total length Tc [s] of a content, in other words when reproduction of the entire content is not finished in the moving time T [s] if the content is output at a normal reproduction speed, the divider 313 calculates a reproduction speed of x times by x=Tc/T so as to increase the reproduction speed of the content and finish reproduction of the content within the moving time. Then, the divider 313 divides the content by the number of displays 200_1 to 200_n, n, and saves the created divided data and the calculated reproduction speed x in the contents DB 321 in association with the displays 200_1 to 200_n. For example, in FIG. 3B, the total length of a content C3 is 1.5 times longer than the moving time. Therefore, the reproduction speed x=1.5 is saved in association with divided data C31 to C3n of the content C3. Here, when the moving time T [s] is equal to or longer than the total length Tc [s] of a content, the divider 313 saves the reproduction speed x=1 in association with the divided data of the content so as to reproduce the content at a normal speed.

The output controller 314 controls output of a content to the displays 200_1 to 200_n based on the moving conditions of the escalator 100. Specifically, the output controller 314 changes the content to output to the displays 200_1 to 200_n in every unit time determined based on the moving conditions of the escalator 100.

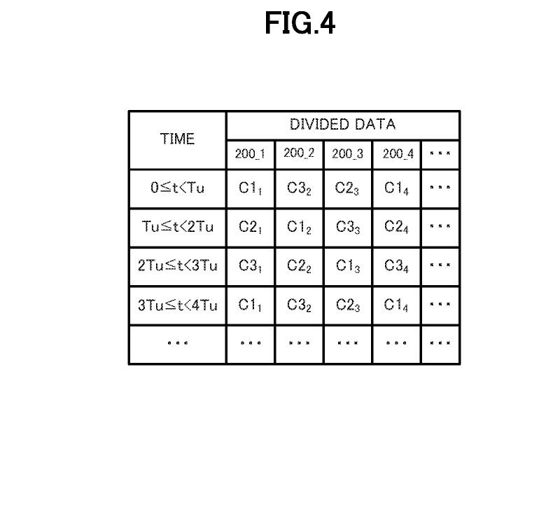

Exemplary change in the content output to the displays 200_1 to 200_n by the output controller 314 will be described below using FIG. 4. FIG. 4 is a chart showing transition with time of divided data the output controller 314 outputs to the displays 200_1 to 200_n. In FIG. 4, for easier understanding, a case in which the output controller 314 outputs the divided data of three contents C1 to C3 to the displays 200_1 to 200_n in sequence is shown. Starting the output control procedure, say at a start time t=0, the output controller 314 outputs to the display 200_1 divided data C11 of a content C1 while 0≦t<Tu, divided data C21 of a content C2 while Tu≦t<2Tu, divided data C31 of a content C3 while 2Tu ≦t<3Tu, and the divided data C11 of the content C1 while 3Tu ≦t<4Tu. Moreover, after t=4Tu, the output controller 314 similarly outputs to the display 200_1 the divided data associated with the display 200_1 in sequence in every unit time with reference to the contents DB 321.

Moreover, the output controller 314 similarly outputs to the other displays 200_2 to 200_n divided data associated with the displays 200_2 to 200_n in sequence in every unit time with reference to the contents DB 321. Specifically, the output controller 314 outputs to the M-th display 200_m the m-th divided data of a content Ck (k is a natural number satisfying 1≦k≦a when the number of contents is a) that is output to the M−1-th display 200_m−1 in the immediately preceding unit time. For example, when the output controller 314 outputs divided data C21 of a content C2 to the display 200_1 while Tu≦t<2Tu, the output controller 314 outputs divided data C22 of the content C2 to the display 200_2 while 2Tu ≦t<3Tu. As just described, the output controller 314 changes the content to output to the displays 200_1 to 200_n in sequence in every unit time, whereby the user who gets on the escalator 100 at, for example, t=0 can view details in the content C1 in sequence in time with the movement of the escalator 100, such as viewing the divided data C11 of the content C1 while 0≦t<Tu, the divided data C12 of the content C1 while Tu≦t<2Tu, and the divided data C13 of the content C1 while 2Tu ≦t<3Tu.

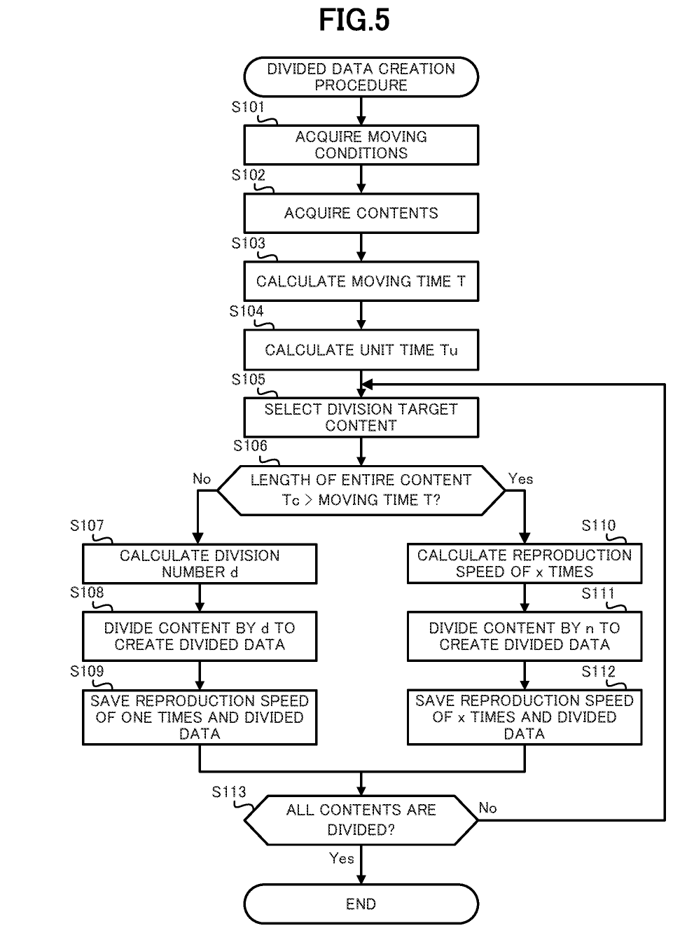

The divided data creation procedure executed by the controller 301 of the output control device 300 according to this Embodiment 1 will be described next. FIG. 5 is an exemplary flowchart of the divided data creation procedure according to this Embodiment 1. Triggered by, for example, the controller 301 receiving operation input presenting the start of this procedure from the user via the inputter 304, this divided data creation procedure starts.

First, the moving condition acquirer 311 acquires moving conditions of the escalator 100 from the control device 108 (Step S101). In this embodiment, the moving condition acquirer 311 acquires the moving speed, moving distance, and moving direction of the escalator 100 as the moving conditions.

Next, the content acquirer 312 acquires one or multiple contents (Step S102).

Next, the divider 313 calculates the moving time T of the escalator 100 from the moving speed and moving distance acquired in the Step S101 (Step S103).

Next, the divider 313 calculates a unit time Tu from the moving time acquired in the Step S103 and the number of displays 200_1 to 200_n, n (Step S104).

Next, the divider 313 selects a content of which divided data have not been created yet as a division target among the contents acquired in the Step S102 (Step S105).

The divider 313 judges whether the total length Tc of the division target content selected in the Step S105 is longer than the moving time T calculated in the Step S103 (Step S106).

If the total length Tc of the division target content is not longer than the moving time T (Step S106; No), the divider 313 divides the total length Tc of the division target content by the unit time calculated in the Step S104 to calculate a division number d (Step S107).

Then, the divider 313 divides the division target content by the division number d calculated in the Step S107 to create divided data (Step S108).

Then, the divider 313 saves the divided data created in the step S108 and the reproduction speed of one times in the contents DB 321 in association with the displays 200_1 to 200_n (Step S109). Then, the divider 313 proceeds to the processing in Step S113.

If the total length Tc of the division target content is longer than the moving time T (Step S106; Yes), a reproduction speed of x times is calculated from the length Tc of the entire division target content and the moving time T (Step S110).

Then, the divider 313 divides the division target content by the division number n corresponding to the number of displays 200_1 to 200_n, n, to create divided data (Step S111).

Then, the divider 313 saves the divided data created in the step S111 in the contents DB 321 in association with the reproduction speed of x times calculated in the Step S110 (Step S112).

Then, the divider 313 judges whether all contents acquired in the Step S102 are divided (Step S113). If judged that not all contents are divided (Step S113; No), the divider 313 returns to the Step S105 and repeats the subsequent processing. On the other hand, if judged that all contents are divided (Step S113; Yes), the divider 313 ends the divided data creation procedure.

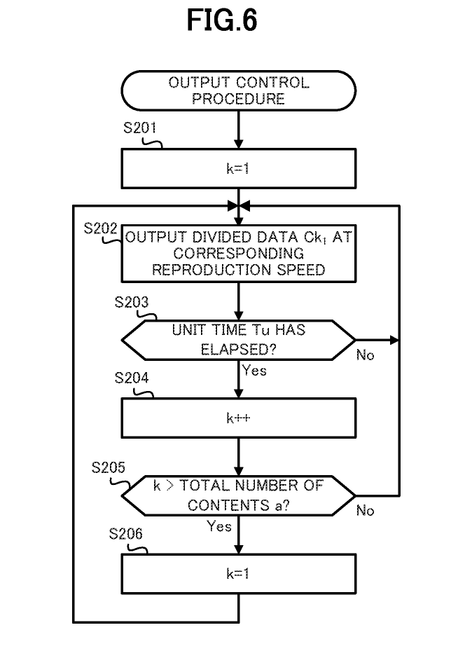

The output control procedure executed by the controller 301 of the output control device 300 according to this Embodiment 1 will be described next. FIG. 6 is an exemplary flowchart of the output control procedure according to this Embodiment 1. Triggered by, for example, the output control device 300 being powered on, this output control procedure starts. Here, it is assumed that the divided data as shown in FIG. 3B are presaved in the contents DB 321. Moreover, the output control procedure to control output of contents to the display 200_1 will be described below by way of example.

First, the output controller 314 sets the number of a content to output, k, to an initial value of 1 (Step S201).

Next, the output controller 314 outputs divided data Ck1 at the corresponding reproduction speed with reference to the contents DB 321 (Step S202).

Next, the output controller 314 judges whether the unit time Tu has elapsed since output of the divided data Ck1 starts in the Step S202 (Step S203). The output controller 314 continues to output the divided data Ck1 until the unit time Tu has elapsed (Step S203; No).

If the unit time Tu has elapsed since output of the divided data Ck1 starts (Step S203; Yes), the output controller 314 increments the content number k (Step S204).

Next, the output controller 314 judges whether the content number k is higher than the total number of contents, a (Step S205). If the content number k is not higher than the total number of contents, a (Step S205; No), the output controller 314 returns to the processing in the Step S202 and repeats the subsequent processing.

If the content number k is higher than the total number of contents, a (Step S205; Yes), the output controller 314 sets the content number k to 1 (Step S206), and returns to the processing in the Step S202 and repeats the subsequent processing.

With the above processing, the output controller 314 outputs the divided data C11 to Ca1 of the contents C1 to Ca to the display 200_1 in sequence in every unit time Tu. Here, the output controller 314 executes the similar output control procedure for the other displays 200_2 to 200_n in parallel.

As described above, the output control device 300 according to this Embodiment 1 controls output of contents to the displays 200_1 to 200_n based on the moving conditions of the escalator 100 and thus can output contents to the displays 200_1 to 200_n according to the movement of the user on the escalator 100.

Moreover, the output control device 300 changes contents to the displays 200_1 to 200_n in every unit time determined based on the moving conditions of the escalator 100 and thus can output to the displays 200_1 to 200_n contents corresponding to the position of the moving user.

Furthermore, the output control device 300 outputs divided data created by dividing a content according to the number of displays 200_1 to 200_n, n, in association with the displays 200_1 to 200_n in sequence in the moving direction of the escalator 100. Therefore, the user on the escalator 100 can follow the content in sequence in time with his movement. Moreover, the user becomes aware of an idea of following the content in sequence, whereby it is possible to suppress dangerous behavior such as walking or running on the escalator.

### Embodiment 2

With regard to the output control device 300 according to the above Embodiment 1, a case is described in which a content is divided based on the number of displays 200_1 to 200_n, n, to create divided content segments as divided data. In this Embodiment 2, a case in which images extracted from the divided content segments are created as divided data is described as another example of creating divided data. Here, the same components as in Embodiment 1 are referred to by the same reference numbers and their detailed explanation is omitted.

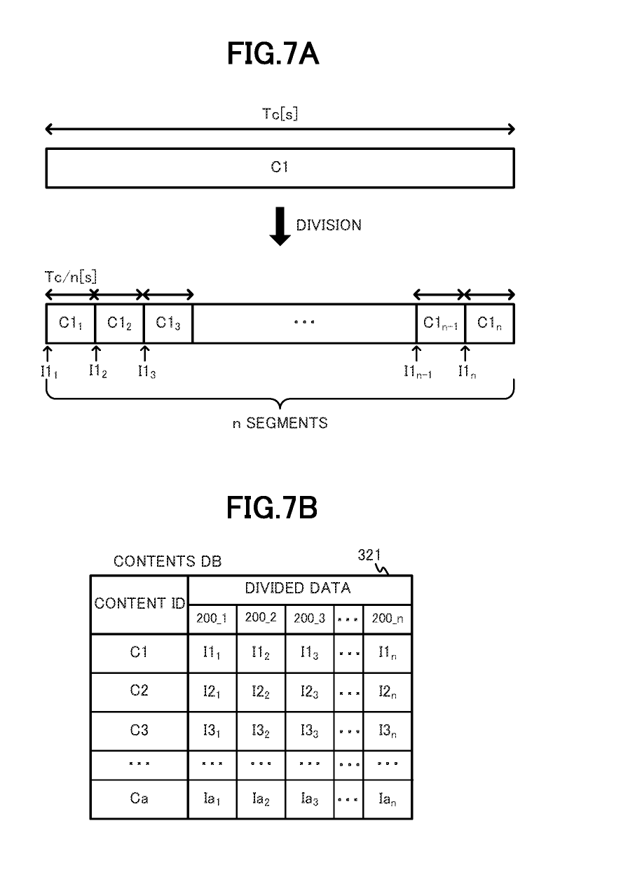

A method of creating divided data according to this Embodiment 2 and exemplary saving in the contents DB 321 will be described using FIGS. 7A and 7B. FIG. 7A is a chart showing an exemplary method of dividing a content and FIG. 7B is a chart showing exemplary data saved in the contents DB 321. In this example, the divider 313 divides a content by the number of displays 200_1 to 200_n, n, and creates images extracted from the divided content segments as divided data. For example, as shown in FIG. 7A, when the total length of a content C1 is Tc [s], the divider 313 divides the content C1 by n into times Tc/n [s] to create n segments C11 to C1n. Then, the divider 313 extracts, for example, the first image from each of the n segments C11 to C1n to create divided data I11 to I1n.

Then, the divider 313 saves each of the created divided data in the contents DB 321 in association with each of the displays 200_1 to 200_n in sequence from the beginning of the content in accordance with the moving direction of the escalator 100. For example, as n divided data I11 to I1n are created from a content C1 as shown in FIG. 7A, the divider 313 saves the divided data I11 to I1n in the contents DB 321 in association with the displays 200_1 to 200_n as shown in FIG. 7B.

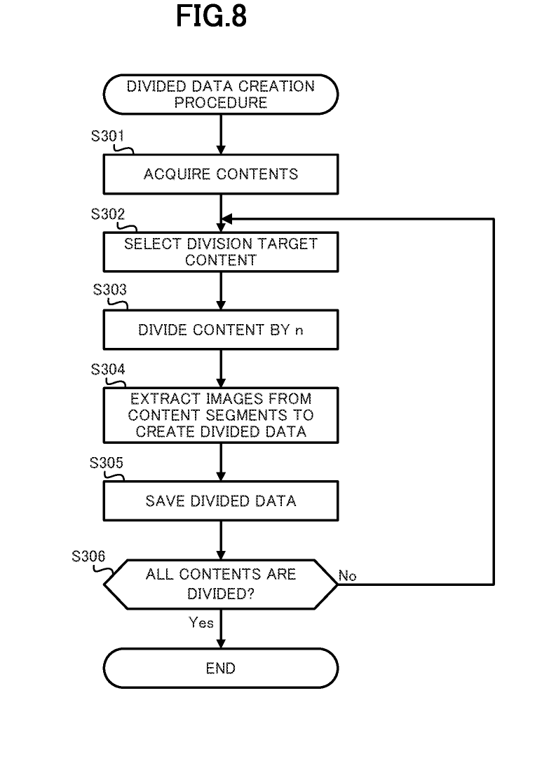

The divided data creation procedure executed by the controller 301 of the output control device 300 according to this Embodiment 2 will be described next. FIG. 8 is an exemplary flowchart of the divided data creation procedure according to this Embodiment 2. Triggered by, for example, the controller 301 receiving operation input presenting the start of this procedure from the user via the inputter 304, this divided data creation procedure starts.

First, the content acquirer 312 acquires one or multiple contents (Step S301).

Next, the divider 313 selects a content of which divided data have not been created yet as a division target among the contents acquired in the Step S301 (Step S302).

Then, the divider 313 divides the division target content selected in the Step S302 by the number of displays 200_1 to 200_n, n (Step S303).

Then, the divider 313 extracts one image from each of the content segments divided in the Step S303 to create divided data (Step S304).

Then, the divider 313 saves the divided data created in the Step S304 in the contents DB 321 in association with the displays 200_1 to 200_n (Step S305).

Next, the divider 313 judges whether all contents acquired in the Step S301 are divided (Step S306). If judged that not all contents are divided (Step S306; No), the divider 313 returns to the Step S302 and repeats the subsequent processing. On the other hand, if judged that all contents are divided (Step S306; Yes), the divider 313 ends the divided data creation procedure.

The divided data created in the above procedure are output to the displays 200_1 to 200_n in sequence in every unit time as in Embodiment 1 by the output controller 314. However, the divided data in this Embodiment 2 are images. Therefore, the displays 200_1 to 200_n continuously display an image presented by the divided data during the unit time.

As described above, the output control device 300 according to this Embodiment 2 divides a content by the number of displays 200_1 to 200_n, n, to create divided data, whereby the user on the escalator 100 can view the entire content while moving regardless of the length of the content.

Embodiments are described above. The above-described embodiments are given by way of example. The specific configuration of the output control device 300 and the details of the divided data creation procedure and output control procedure are not confined to those described in the above embodiments and can be modified as follows.

For example, in the above-described Embodiments 1 and 2, the explanation is made using the escalator 100 as an example of the moving device. The moving device in the present disclosure is not restricted thereto. The moving device is something moving on a predetermined route and may be, for example, a moving walkway, an elevator, a train, or a bus. For example, when the moving device is an elevator, the output control device 300 may acquire information presenting the floors the elevator stops as a moving condition. Moreover, the output control device 300 may acquire the moving time required for the moving device to move on a predetermined route as a moving condition. For example, the output control device 300 may calculate a moving time based on the number of floors the elevator moves through and control output of a content based on the moving time. Moreover, the output control device 300 may select one destination among multiple destinations included in a predetermined route of the moving device, for example a floor number in the case of an elevator, and acquire the selected destination as a moving condition. Then, the output control device 300 may control output of a content based on the moving time required to move to the selected destination.

Moreover, in the above-described Embodiments 1 and 2, a case is described in which the output control device 300 changes the content to output to the displays 200_1 to 200_n in every unit time determined based on the moving conditions of the escalator 100. However, the method of changing the content is not restricted thereto. For example, the output control device 300 may change output of a content based on the moving speed of the moving device. For example, the output control device 300 may output still images of a content to the displays while the moving device is at rest and output video images of the content to the displays while the moving device is moving. Moreover, the output control device 300 may start outputting a content to the displays when detecting the displays starting to move.

Moreover, in the above-described Embodiments 1 and 2, a case is described in which the output control device 300 acquires the moving conditions of the escalator from the control device 108 of the escalator 100. However, the method of acquiring the moving conditions of the moving device is not restricted thereto. For example, the output control device 300 may acquire the moving conditions from the user via the inputter 304.

Moreover, in the above-described Embodiments 1 and 2, a case is described in which multiple displays 200_1 to 200_n are arranged at equal intervals. However, only one display may be provided. Moreover, the distances between multiple displays 200_1 to 200_n may not be equal. In such a case, the output control device 300 can obtain the same efficacy as in the above Embodiments 1 and 2 by preliminarily acquiring the distances between multiple displays 200_1 to 200_n and controlling output of a content in every unit time of each of the displays 200_1 to 200_n that is calculated based on the acquired distance.

Moreover, the output control device 300 according to the present disclosure can be realized by a conventional computer, not by a dedicated device. For example, the output control device 300 may be realized by a computer executing programs. The programs for realizing the function of the output control device 300 may be stored on a non-transitory computer-readable recording medium such as a universal serial bus (USB) memory, a compact disc read only memory (CD-ROM), a digital versatile disc (DVD), and an HDD, or downloaded on a computer via a network.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. An output control system, comprising:
a display outputting a content;
an acquirer acquiring a moving condition of a moving device; and
a CPU changing output of the content to the display based on the acquired moving condition.

2. The output control system according to claim 1, wherein
the CPU changes the content to output to the display in every unit time determined based on the acquired moving condition.

3. The output control system according to claim 2, wherein
the CPU
divides the content,
controls output of the content to multiple displays disposed along a moving direction of the moving device,
divides the content based on the number of multiple displays to create divided data of the content and associates each of the divided data with each of the multiple displays in sequence from the beginning of the content in accordance with the moving direction, and
controls output of each of the divided data to the associated display.

4. The output control system according to claim 3, wherein
the CPU determines as the unit time a time for which each of the multiple displays outputs the divided data based on the acquired moving condition and the number of multiple displays and divides the content into the unit times.

5. The output control system according to claim 3, wherein
the CPU divides the content by the number of displays.

6. The output control system according to claim 5, wherein
the CPU controls output of each of the divided data to the associated display at a reproduction speed at which the entire divided data are reproduced in the unit time when the total length of the content is longer than the total of the unit times of the multiple displays.

7. The output control system according to claim 5, wherein
the CPU creates images extracted from each of the divided data as the divided data.

8. The output control system according to claim 1, wherein
the CPU starts to control outputting the content to the display when detecting the moving device starting to move.

9. The output control system according to claim 1, wherein
the CPU changes output of the content based on a moving speed of the moving device.

10. The output control system according to claim 1, wherein
the acquirer acquires the moving condition of the moving device moving on a predetermined route.

11. The output control system according to claim 10, wherein
the acquirer acquires as the moving condition a moving time required for the moving device to move on the predetermined route.

12. The output control system according to claim 10, wherein
the CPU selects one destination from among multiple destinations included in the predetermined route, and
the acquirer acquires the selected destination as the moving condition.

13. An output control method, including:
a display step of outputting a content on a display;
an acquisition step of acquiring a moving condition of a moving device; and
an output control step of changing output of the content to the display based on the acquired moving condition.

14. A non-transitory computer-readable recording medium, allowing a computer to execute:
a display process of outputting a content on a display;
an acquisition process of acquiring a moving condition of a moving device; and
an output control process of changing output of the content to the display based on the acquired moving condition.
